(19) United States
(12) Patent Application Publication
(10) Pub. No.: US 2015/0291382 A1
(43) Pub. Date: Oct. 15, 2015

(54) METHODS OF PRODUCING PRINTED PACKAGING

(71) Applicant: Chee Cheong Moh, Singapore (SG)

(72) Inventor: Chee Cheong Moh, Singapore (SG)

(21) Appl. No.: 14/390,269

(22) PCT Filed: Apr. 2, 2012
(86) PCT No.: PCT/SG2012/000117

§ 371 Date: May 12, 2015

(51) Int. Cl. B65H 43/04; B65H 43/08; B31B 1/88

(52) U.S. Cl. CPC B65H 43/04; B31B 1/88; B65H 43/08

(57) ABSTRACT

The present invention provides methods of producing packaging for use in consumer goods packaging. In one embodiment, the method includes providing a plurality of printable substrates having pre-printed static information thereon; printing variable information on the plurality of printable substrates, inspecting the static information of each of the plurality of printable substrates; and inspecting the variable information of each of the plurality of printable substrates. The present invention is advantageous in that inspecting the static information and inspecting variable information are carried out at a same time therefore production efficiency is improved. In addition, inspection is done against separated individual printable substrates hence if any defect is detected, only the defected substrate needs to be discarded hence wastage rate is reduced.

### TECHNICAL FIELD

Embodiments of the invention relate generally to methods of producing printed packaging, in particular, to methods of producing and inspecting printed packaging with printings/markings/labels bearing static and variable information.

### BACKGROUND

FIG. 1 illustrates a method 10 for producing printed packaging with variable information and static information. A raw material sheet or paperboard for constructing two or more packages is first provided on which multiple variable information such as barcodes, numbering, etc. are printed on the paperboard (block 11). An inspection of the variable information printed on the paperboard is then carried out to detect defects in the printed variable information (block 12). If any of the printed variable information is defective, the entire paperboard is discarded. If the printed variable information is acceptable, the paperboard containing the variable information is subsequently printed with static information (block 13). Other finishing steps, e.g. lamination or coating, may also be carried out. Thereafter, the paperboard containing the variable and static information may be die cut into individual packages (block 14). The individual packages are then inspected for defects (block 15 & block 16). Defective packages are discarded or diverted (block 17) while non-defective packages may proceed to finishing steps, e.g. folding and gluing (block 18).

There are several disadvantages associated with the approach described above. Firstly, there is substantial wastage as an entire paperboard is discarded even if a small portion of the printed information on the paperboard is defective. Multiple printing or processing steps on a same paperboard are likely to result in lower print accuracy and therefore increased defects. For example, after a first printing step is performed on a paperboard, the paperboard may undergo certain physical changes, e.g. stretching, which potentially results in misaligned printouts after a second printing step is performed on the same paperboard. In another example, a paperboard with printed information that has passed inspection may become exhibit misalignment after a die cut process.

Secondly, as inspection is carried out after printing variable information as well as after printing static information, and is often done manually, the production process is considerably slowed and wastage is increased with multiple inspection steps. However, multiple inspection steps may be necessary in the production of printed packaging for certain industries, e.g. pharmaceutical and medical products, where regulatory requirements relating to packaging quality are stringent.

### SUMMARY OF THE INVENTION

Embodiments of the invention provide methods of producing printed packaging, potentially at an output level of hundred thousand pieces a day within a single printing system. These methods would greatly improve productivity and efficiency, reduce wastage, and are more environmentally friendly.

In one embodiment, a method of producing packaging for use in consumer goods packaging includes providing a plurality of printable substrates having pre-printed static information thereon; printing variable information on the plurality of printable substrates, inspecting the static information of each of the plurality of printable substrates; and inspecting the variable information of each of the plurality of printable substrates. The present invention is advantageous in that inspecting the static information and inspecting variable information are carried out at a same time therefore production efficiency is improved. In addition, inspection is done against separated individual printable substrates hence if any defect is detected, only the defected substrate needs to be discarded hence wastage rate is reduced.

### BRIEF DESCRIPTION OF THE DRAWINGS

Embodiments of the invention are disclosed hereinafter with reference to the drawings, in which:

FIG. 1 illustrates a conventional method of producing a printed packaging;

FIG. 2 illustrates a method of producing a printed packaging according to one embodiment of the invention; and

FIG. 3 is a block diagram of a printing system according to one embodiment of the invention.

### DETAILED DESCRIPTION

In the following description, numerous specific details are set forth in order to provide a thorough understanding of various illustrative embodiments of the invention. It will be understood, however, to one skilled in the art, that embodiments of the invention may be practiced without some or all of these specific details. In other instances, well known process operations have not been described in detail in order not to unnecessarily obscure pertinent aspects of embodiments being described. In the drawings, like reference numerals refer to same or similar functionalities or features throughout the several views.

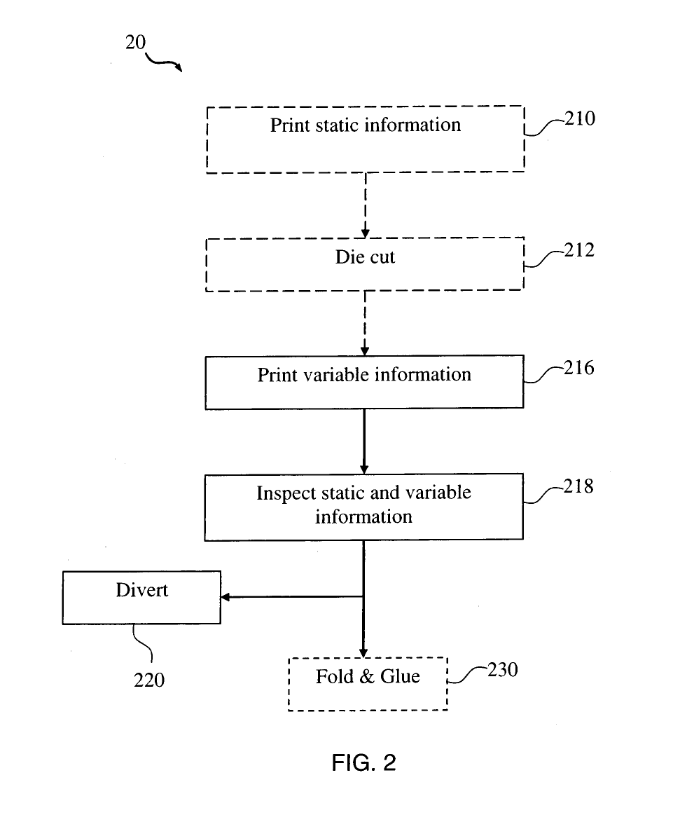

Reference is made to FIG. 2 which illustrates a method 20 of producing printed packaging according to one embodiment of the invention. The method begins with printing static or fixed information on a sheet of material, e.g. paperboard (block 210). Outlines of individual package shape may also be printed at this stage. Static or fixed information generally refers to printed material or information that does not change from package to package. Static information may include product information that describes the contents or characteristics of a product to be packed in the finished package. The method 20 may include applying a finish, e.g. surface coating, on the sheet of material having static information printed thereon.

The method 20 then proceeds to die cutting where the sheet of material is die cut to obtain a plurality of separated individual printable substrates of desired shapes (block 212). Particularly, the printable substrates are separated from the sheet of material and from one another. Die-cutting generally refers to a method for punching or cutting out pre-defined shapes from a paperboard sheet by using a metal form, e.g. a die, which may be a steel blade suitably arranged to punch out individual printable substrates with a desired shape and outline.

The method 20 then proceeds to providing the die-cut or separated printable substrates pre-printed with static information (from block 212) for variable information printing (block 216). Also, the printable substrates are provided in an unassembled or unfolded form. Variable information generally refers to information which changes from package to package, or is unique to each package substrate. Examples of variable information include, but are not limited to, a series of unique barcodes, a series of unique numerical identifiers and a series of unique alphanumeric identifiers.

After printing of variable information is completed, the method 20 then proceeds to inspecting the printable substrates containing static and variable information printouts (block 218), i.e. to carry out static information inspection and variable information inspection at the same time. Particularly, the printable substrates are inspected to detect any defect in the static and variable information printouts, thereby identifying any defective printable substrates to be removed. Examples of defects on variable information include, but are not limited to, no-print, mismatched print, low-graded barcode print, misalignment. Examples of defects on static information include, but are not limited to, splashes, spots, streaks, scratches, missing print, color deviations, smearing, discoloration, register variations, and doubled images. The inspection step may include assigning a grade to each printable substrate based on the quality of a printout of the variable information. For variable information containing barcodes, the parameters for assessing quality may be specified by industry standards such as ANSI X3.182 standard. Each grade may involve satisfying one or more quality criteria. For example, it is possible to assign different grades to a production lot depending on the customer's requirements. Any printable substrates which have been produced at a grade below the assigned level will be detected as defect substrate, and will be diverted away or removed from subsequent processing. The inspection step may also include verifying each printout of the variable information against a database containing the variable information. For example, an actual printout may, due to misprinting, contain a variable information which is non-existent or duplicated in the database, thereby resulting in a mismatched print.

In the above description, the steps involving printing of variable information (block 216) and inspecting printable substrates containing static and variable information printouts (block 218) are carried out within a same printing equipment.

After inspecting the printable substrates for static information and variable information as described above, defective printable substrate(s), if any, are identified based on examples of variable defects and examples of static defects, and such defective printable substrates are diverted (block 220) from the main production line. The method then proceeds to one or more finishing steps, e.g. folding and gluing, where the remaining plurality of printable substrates of acceptable quality are assembled to form a plurality of packages (block 230). After assembling into packages suitable for packing consumer goods therein, the relevant consumer good, e.g. pharmaceutical product, food product, electronic product, may be subsequently packaged or received into each of the packages.

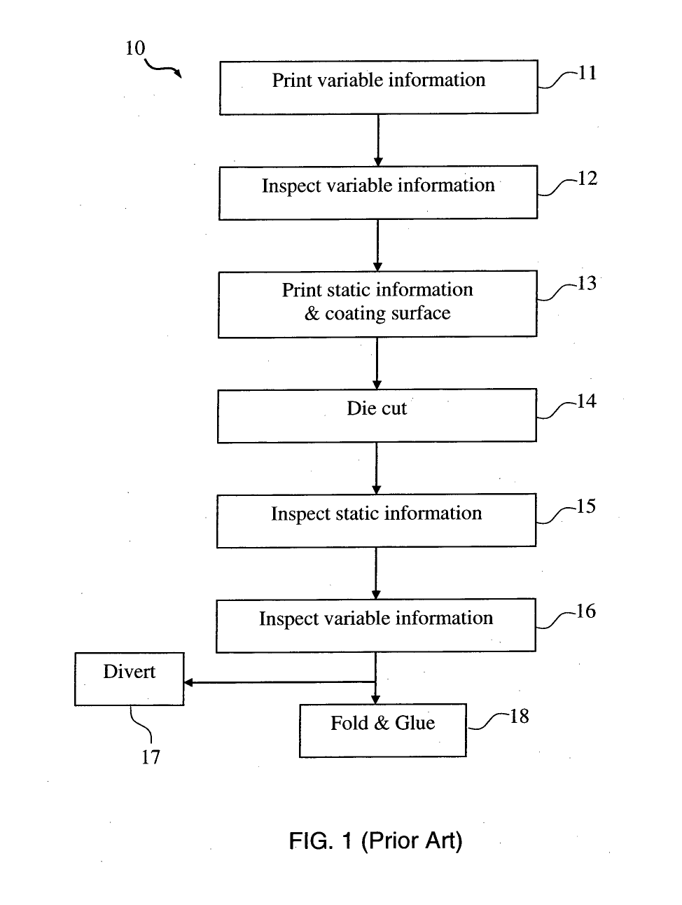

The above method 20 of FIG. 2 is particularly advantageous compared over the method 10 illustrated by FIG. 1 which involves additional inspection step, inevitably resulting in usage of more resources and more wastage since an entire sheet of material has to be discarded if a defect is found on any part or on any package outline on the sheet of material. In contrast, the method 20 according to one embodiment of the invention requires lesser inspection step as the method 20 defers inspection at least until after the printable substrates are die cut and all static and variable information are printed, so that only individual defective substrates need to be discarded.

Another advantage of the above method 20 of FIG. 2 is the flexibility in the number of substrates to print. In the method 10 of FIG. 1, a whole sheet of material, typically yielding six to twenty product packages, needs to be printed regardless of the number of product packages required. In contrast, the method 20 according to one embodiment of the invention allows a smaller number of packages to be printed, thus even a single product package can be printed. This way, additional printing due to discarding of defective packages requires less wastage and hence is more eco-friendly.

Also, with the reduction in process steps, the above method 20 would consume lesser power, e.g. one-third of the power requirements of method 10, as well as production floor space. Additionally, inspection of the above method 20 may be automated and therefore replaces labour-intensive inspection in prior art methods. Moreover, with the variable information print after static information was pre-printed, the above method 20 would improve productivity and efficiency. For example, blank sheet materials may have static information printed in advance, but will not proceed to subsequent die-cutting and variable information printing processes until a confirmed instruction from customer/user is received. Sheet materials with static information printed thereon may be temporarily stored at this stage. When an instruction is received from customer/user to supply packages with printings/markings/labels bearing both the static and variable information, instead of producing the desired packages from printing static information on blank sheet materials, the process can be started by die cutting the temporary stored sheet materials which already have static information printed thereon, and further proceed to variable information printing. Solutions provided by the present invention are therefore more efficient in fulfilling customer/user's requirements in particular when urgent delivery of finished packages is needed,

In certain products, e.g. pharmaceutical and medical products, due to stringent regulatory requirements, product identification, labelling and tracking are of paramount importance and therefore a high quality is required in the product packaging. In order to ensure a certain quality in the printed packaging, wastage level of intermediate packaging substrate is very high in prior art methods. However, as appreciated from the foregoing description, embodiments of the invention are capable of achieving a high quality printed packaging at reduced wastage.

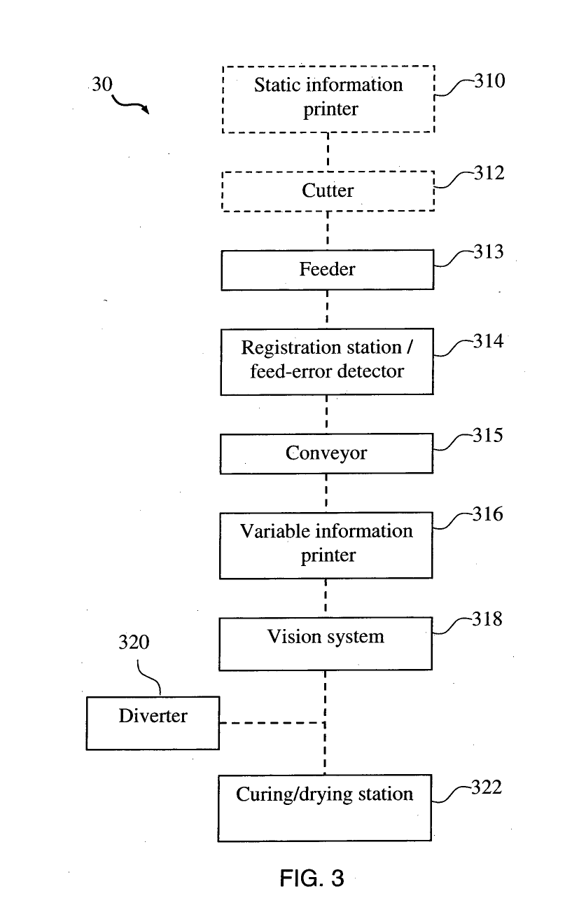

Reference is made to FIG. 3 which illustrates a printing system 30 for implementing the method 20 of FIG. 2. The printing system 30 may include a static information printer 310 for printing static information onto blank sheet materials which, upon completion of printing of static information, are sent to a cutter 312 for cutting, e.g. die-cutting, to form separate individual printable substrates. A feeder 313 is then used for loading die cut printable substrates into a hopper which feeds the printable substrates into a registration station or feed-error detector 314. Registration station 314 may also include a sensor for detecting feeding errors such as double feeds. The registration station 314 aligns the printable substrate consistently on a transport conveyor 315 which, supplies. each printable substrate down the transport conveyer to a variable information printer 316. As the printable substrate passes under a fixed print head of printer 316, e.g. an inkjet printer, variable information printer 316 prints variable information onto the printable substrate. A vision system 318 is provided to inspect the static and variable information on the printable substrate for defects after the printing. If the printable substrate is defective, it is diverted away by a diverter 320. If the printable substrate has printed static and variable information of acceptable quality, the printable substrate is forwarded to a curing station 322, for drying or curing, e.g. ultraviolet curing.

Other embodiments will be apparent to those skilled in the art from consideration of the specification and practice of the invention. Furthermore, certain terminology has been used for the purposes of descriptive clarity, and not to limit the disclosed embodiments of the invention. The embodiments and features described above should be considered exemplary, with the invention being defined by the appended claims.

1. A method of producing packaging for use in consumer goods packaging, the method comprising:
providing a plurality of printable substrates having pre-printed static information thereon;
printing variable information on the plurality of printable substrates, wherein the variable information is unique to each of the plurality of printable substrates;
inspecting the static information of each of the plurality of printable substrates; and
inspecting the variable information of each of the plurality of printable substrates,
wherein inspecting the static information and inspecting variable information are carried out at a same time.

2. The method according to claim 1, wherein providing a plurality of printable substrates includes providing the plurality of printable substrates in an unfolded form.

3. The method according to claim 1, wherein the variable information includes one of a series of unique barcodes, a series of unique numerical identifiers and a series of unique alphanumeric identifiers.

4. The method according to claim 3, wherein inspecting the variable information of the plurality of printable substrates includes assigning a grade to each of the plurality of printable substrates based on the printout of the variable information on the each of the plurality of printable substrates.

5. The method according to claim 4, wherein inspecting the variable information of the plurality of printable substrates includes verifying the printout of the variable information of the each of the plurality of printable substrates against a database containing the variable information.

6. The method according to claim 5, further comprising: after inspecting the static information and the variable information of each of the plurality of printable substrates, identifying at least a defective one of the plurality of printable substrates based on the assigned grade and the verification of the printout of the variable information; and diverting the defective one of the plurality of printable substrates.

7. The method according to claim 6, further comprising: after diverting a defective one of the plurality of printable substrates, assembling each of the remaining plurality of printable substrates to form a plurality of packages.

8. The method according to claim 1, wherein the static information includes at least one of textual information, graphical information and image information.

9. The method according to claim 8, wherein inspecting the static information of the plurality of printable substrates includes detecting at least one of splashes, spots, streaks, scratches, missing print, color deviations, smearing, discoloration, register variations, and doubled images.

10. The method according to claim 1, wherein the consumer good is one of a pharmaceutical product, a food product and an electronic product.

11. The method according to claim 1 further comprising, prior to providing a plurality of printable substrates, separating a sheet material to form the plurality of printable substrates.

12. The method according to claim 11 further comprising, prior to separating the sheet of material, printing static information on the sheet of material.

13. The method according to claim 1, wherein printing variable information and inspecting static information and variable information are carried out within a same printing equipment.
